(19) United States
(12) Patent Application Publication
(10) Pub. No.: US 2024/0226973 A9
(43) Pub. Date: Jul. 11, 2024

(54) GEOLOGICAL REPOSITORY

(71) Applicant: TN Americas LLC, Columbia, MD (US)

(72) Inventors: Ahmad Salih, Elkridge, MD (US); Uwe Wolf, Silver Spring, MD (US)

(73) Assignee: TN Americas LLC, Columbia, MD (US)

(21) Appl. No.: 18/491,339

(22) Filed: Oct. 20, 2023

Related U.S. Application Data
(60) Provisional application No. 63/380,466, filed on Oct. 21, 2022.

(51) Int. Cl. B09B 1/00; B65G 1/04; G21F 9/34

(52) U.S. Cl. CPC B09B 1/008; B09B 1/006; B65G 1/045; G21F 9/34

(57) ABSTRACT

A geological repository includes a subterranean spiral tunnel drilled or bored in a geological formation. The geological repository further includes spaced-apart storage compartments individually accessible from the spiral tunnel. The storage compartments are configured to receive storage canisters transported through the spiral tunnel. The plurality of storage compartments are formed in a body of rock.

### CROSS-REFERENCE TO RELATED APPLICATION

This application claims the benefit of Provisional Application No. 63/380,466, filed Oct. 21, 2022, the entire disclosure of which is hereby incorporated by reference herein for all purposes.

### BACKGROUND

Radioactive and other hazardous waste, irradiated hardware and other chemically contaminated material/hardware may be stored in geological repositories. Geological repositories are constructed underground at a depth of a few feet to several thousand feet below ground surface. Geological repositories consist of a combination of waste form, waste package, engineered barriers and geology that is suited to provide a long-term isolation and containment. Existing designs are generally single elevation, un-inspectable and with storage containers/casks that are grouped in a single storage enclosure. See for example U.S. Pat. No. 8,933,289 to Crichlow, which is hereby incorporated by reference in its entirety. See also, U.S. Pat. Appl. Publ. 2017/0050865 to Denton et al., which is hereby incorporated by reference in its entirety.

There exists a need for an improved design having direct access to each individual storage container/cask. In addition, there exists a need for easy to retrieve, inspectable, multi-level three dimensional geological repositories. Further, there exists a need for improved remote-controlled handling of waste packaging that can be transferred to and from the storage compartments.

### SUMMARY

Embodiments of a geological repository are set forth below according to technologies and methodologies of the present disclosure.

A first representative embodiment of a geological repository includes a subterranean spiral tunnel drilled or bored in a geological formation. The geological repository further includes a plurality of spaced-apart storage compartments individually accessible from the spiral tunnel, wherein the storage compartments are configured to receive storage canisters transported through the spiral tunnel. The plurality of storage compartments are formed in a body of rock.

In some embodiments, the subterranean spiral tunnel comprises a plurality of subterranean spiral tunnels.

In some embodiments, the geological further comprises a vertical shaft extending from an upper ground surface to provide access to the subterranean spiral tunnel.

In some embodiments, the geological further comprises a ramp extending from an upper ground surface to provide access to the subterranean spiral tunnel.

In some embodiments, the vertical shaft extending from the upper ground surface engages the spiral tunnel through a subterranean main hub.

In some embodiments, the geological further comprises a ventilation shaft, a utility shaft, and a ground water management system, wherein the ventilation shaft, the utility shaft, and the ground water management system are fluidly connected to the main hub.

In some embodiments, the plurality of storage compartments extend horizontally or vertically from the spiral tunnel.

In some embodiments, the plurality of storage compartments comprise pairs of aligned storage compartments that extend in opposite directions from the spiral tunnel.

In some embodiments, the plurality of storage compartments comprise multiple layers of barriers.

In some embodiments, the multiple layers of barriers comprise a barrier layer comprising a non-conductive material and a barrier layer comprising a conductive material.

In some embodiments, the spaced apart storage compartments comprise a plurality of closure layers, including at least one engineered layer and at least one natural barrier, wherein the natural barrier comprises a rock barrier.

In some embodiments, the engineered layer comprises a conductive material, and further comprises a second engineered barrier comprising a non-conductive material.

In some embodiments, the vertical shaft comprises a plurality of vertical shafts.

In some embodiments, a system comprises an embodiment of a geological repository, a transfer container configured to receive a storage canister, and a transport device configured to transport the storage canister to a selectable one of the storage compartments. The transport device comprises a track system disposed in the spiral tunnel, and further comprising a transfer device configured to transfer the storage canister from the transfer container to the selected storage compartment.

In some embodiments, the transport device is remotely controlled.

In some embodiments, the transfer device is integrated into the transfer container.

In some embodiments, the transfer device is remotely operated.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 is an isometric view of a geological repository in accordance with one embodiment of the present disclosure;

FIG. 2 is a detail partially cutaway view showing a portion of a spiral tunnel of the geological repository shown in FIG. 1, with a transfer container positioned to engage oppositely disposed storage compartments in the repository;

FIG. 3 is a sectional view showing a storage compartment extending from the spiral tunnel of the geological repository shown in FIG. 1, the storage compartment containing a storage canister;

FIG. 4 is a sectional view showing a storage compartment in another embodiment of a geological repository, wherein a storage compartment extends vertically from the spiral tunnel;

FIG. 5 is a perspective view of a geological repository transfer system for receiving, transporting, and inserting a storage canister into a storage component of the geological repository shown in FIG. 1, and showing a storage canister partially inserted into the transfer container;

FIG. 6 is a perspective view similar to FIG. 5, and with the transfer container and related components shown in phantom to show internal components for transferring the storage canister into the storage compartment;

FIG. 7 is a perspective view of the geological repository transfer system shown in FIG. 5, with the closure of the storage compartment in the closed position;

FIG. 8 is a perspective view of the geological repository transfer system partially in phantom in a transfer configuration for transferring a storage canister into a horizontal storage transfer container or from the transfer container into a storage compartment of the repository;

FIG. 9 is a perspective view of a geological repository transfer system for transferring a storage canister (not shown) into the vertical storage compartment shown in FIG. 4; and

FIG. 10 is a perspective view of the geological repository transfer system shown in FIG. 9, shown partially in phantom and in a transfer configuration for the vertical storage component.

### DETAILED DESCRIPTION

While illustrative embodiments have been illustrated and described, it will be appreciated that various changes can be made therein without departing from the spirit and scope of the disclosure.

The detailed description set forth below in connection with the appended drawings wherein like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, to achieve the same or substantially similar result.

In the following description, numerous specific details are set forth to provide a thorough understanding of exemplary embodiments of the present disclosure. It will be apparent to one skilled in the art, however, that many embodiments of the present disclosure may be practiced without all elements disclosed for the currently preferred embodiment. In some instances, well-known process steps have not been described in detail so as not to unnecessarily obscure various aspects of the present disclosure. Further, it will be appreciated that embodiments of the present disclosure may employ any combination of features described herein.

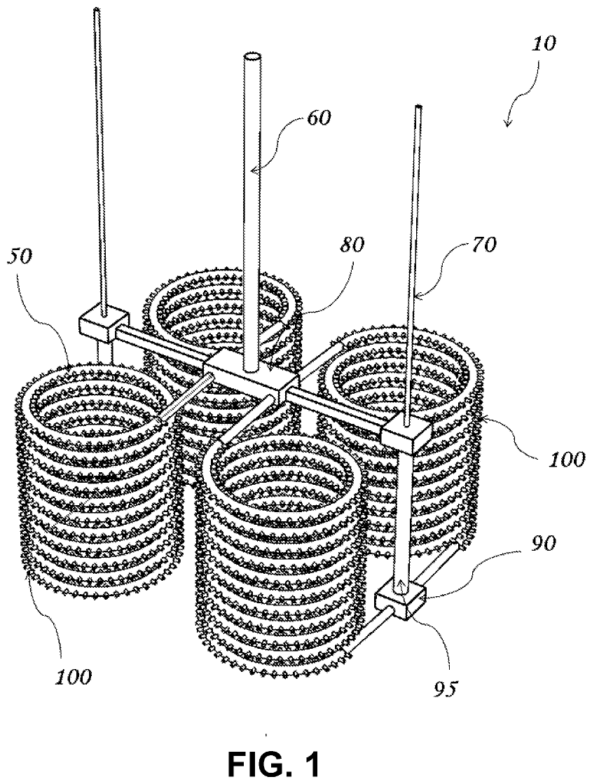

Currently preferred embodiments of the present disclosure are directed to geological repositories suitable, for example, for interim dry storage and/or aging and disposal of radioactive materials. Referring to FIG. 1, a geological repository 10 constructed in accordance with one embodiment of the present disclosure is provided.

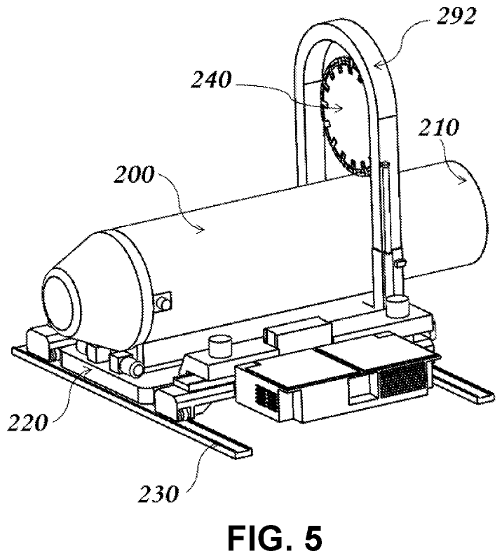

The geological repository 10 in the embodiment of FIG. 1 includes a single or a plurality of access shafts (one shown), for example vertical shaft 60 configured for providing access from a ground surface (not shown) to a corresponding main hub 80. In other embodiments the access shaft is not vertical, for example an access shaft may be slanted and/or arcuate. Waste packaging, for example storage canisters 210 (see, FIG. 5), are transferred through the shaft 60 and are received into the main hub 80.

The geological repository 10 in this embodiment includes four spiral (e.g., helical) tunnels 50 configured for providing access from the main hub 80 to the storage compartments 100. Other embodiments may have more or fewer spiral tunnels 50.

Storage canisters 210 are transferred through a spiral tunnel 50 and inserted into a selected one of the storage compartments 100.

The geological repository 10 in the embodiment of FIG. 1 includes one or more ground water management stations 90 at the lowest elevation of the geological repository 10. Water may be collected at the management station 90 and discharged through utility shafts 95. The geological repository 10 in the illustrated embodiment of FIG. 1 includes ventilation shafts 70.

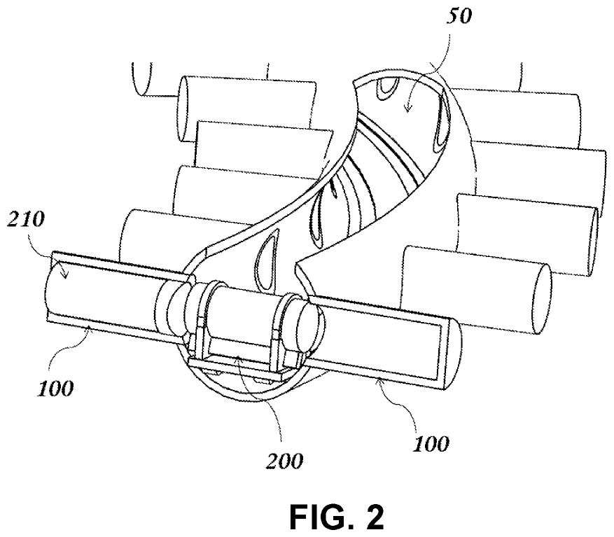

A detail cutaway view of a portion of a spiral tunnel 50 is shown in FIG. 2. The spiral tunnels 50 in the embodiment of FIG. 2 include a track system for transporting waste packaging to a selectable one of the storage compartments 100, providing means for transferring the waste packaging, for example storage canister 210, from the main hub 80 to the storage compartments 100. Other means for transporting the waste packaging to the storage compartments 100 are contemplated, including for example non-tracked, wheeled transports, suspended conveyors, or the like.

A plurality of storage compartments 100 are accessible through the spiral tunnels 50. In the embodiment shown in FIG. 2, each storage compartment 100 is adjacent to, or spaced apart from, one or more other compartments 100. In other embodiments storage compartments 100 may be provided on more than two sides of the spiral tunnel 50. For example, storage compartments 100 may be radially spaced to provide three to six (or more) storage compartments 100 at spaced axial locations along the spiral tunnel 50. In another embodiment a first plurality of storage compartments 100 (for example three storage compartments) may be provided and radially spaced (for example 120 degrees) at a given axial position along the spiral tunnel 50, and at a next axial location a similar plurality of storage compartments 100 may be provided that are radially offset from the first plurality of storage compartments (for example by 60 degrees). A transfer container 200 in the embodiment of FIG. 2 is shown aligned with two storage compartments 100.

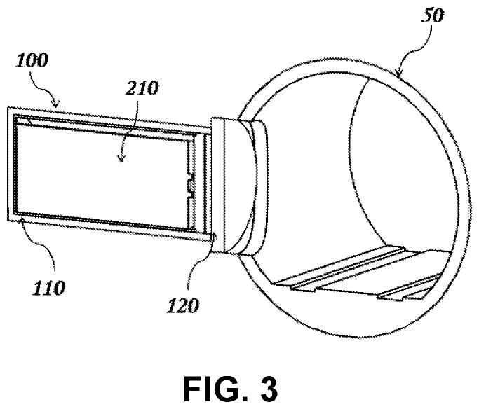

The storage compartment 100 in the embodiment of FIG. 3 is generally horizontally oriented. In some embodiments some or all storage compartments 100 are formed in a native rock formation with one end accessible from the spiral tunnel 50. The storage compartment 100 may have multiple layers of engineered barriers 110. Engineered barriers 110 are provided. The barriers 110 may comprise conductive, non-conductive, and protective materials. In one embodiment, a non-conductive material is placed alongside the native formation and a conductive material is incased by the non-conductive material.

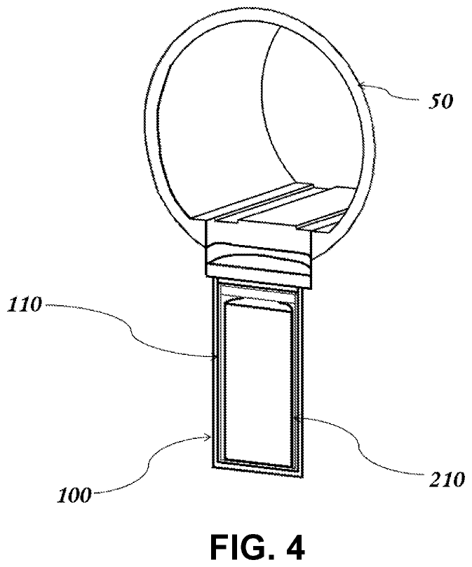

The storage compartment 100 is shown with engineered and non-engineered lid 120. In one embodiment, the engineered lid 120 may comprise conductive, non-conductive, and protective materials. The non-engineered lid 120 may consist of natural stone or rock. The storage compartment 100 in the embodiment of FIG. 4 is vertically oriented. In one embodiment, the storage compartment is formed in a native rock formation with one access to the spiral tunnel 50. The storage compartment 100 may have multiple layers of engineered barriers 110. Engineered barriers 110 may be formed of conductive, non-conductive, and/or protective materials. For example, a non-conductive material may be placed alongside the native formation and a conductive material may be incased by the non-conductive material.

FIG. 5 shows a transfer system including a transfer container 200 configured to receive a storage canister 210. A storage canister 210 is shown partially inserted into the transfer container 200. In an embodiment the storage canister 210 contains nuclear fuel assemblies, for example spend fuel assemblies.

The transfer container 200 is attached to a transport device 220, preferable an unmanned driven transport device. In this embodiment the transport device 220 engages tracks 230 for transporting and transferring storage canisters 210 containing irradiated nuclear fuel into the geological repository 10. A closure device 292 is shown supporting a removable closure 240 of the transfer container 200, the closure 240 providing access for inserting and removing the storage canister 210 from the transfer container 200.

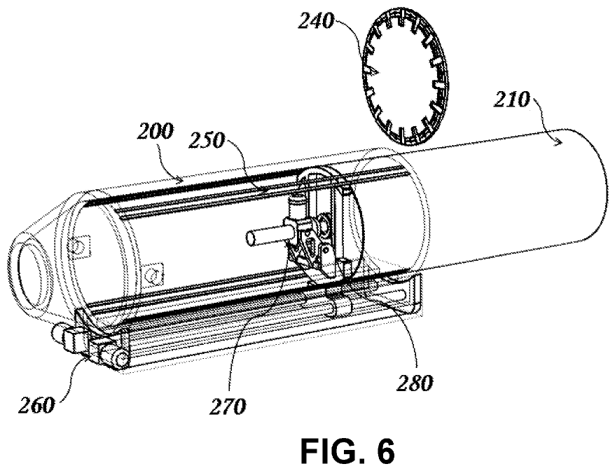

Refer also to FIG. 6 showing the transfer container 200 in phantom defining a cavity for receiving the storage canister 210. Transfer container 200 also includes a closure 240 securable to seal an end portion of the transfer container 200 (closure device 292 not shown). Transfer container 200 further includes a radiation absorbing shield layer, which may include both gamma radiation and neutron radiation absorbing material.

Moreover, a plurality of bearing surfaces 250 are defined longitudinal on the cavity of transfer container 200 and are engageable to enable transferring and hoisting of storage canister 210. Bearing surfaces are constructed to handle the load bearing stress and are of low friction type, and more preferably needle roller bearing type.

As can be observed on this same FIG. 6, transferring and hoisting of storage canister 210 is provided by integrated self-powered mechanism consisting of transfer drive 260 and grapple drive 270. Grapple drive 270 is consisting of a guide structure engaged with bearing surfaces 250 and grapple mechanism grasping grapple ring 280 of storage canister 210. Moreover, grapple drive 270 is axially moved by transfer drive 260 over the entire length of transfer container 200, as a result transferring the storage canister 210 in and out from the transfer container 200. Grapple drive 270 provides additional axial movement for insertion and retraction of storage canister 210 in final deep repository storage location. This sequence of axial movement of storage canister 210 applies for transfer in horizontal direction and hoisting in vertical direction.

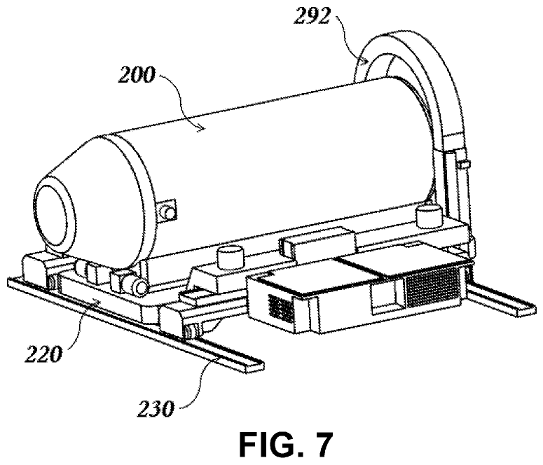

FIG. 7 shows the transport configuration of transfer container 200, which is conveyed with the enclosed storage canister 210 from the deep repository main hub 80 to a selected storage compartment 100. The vertical closure device 292 for closure 240 of transfer container 200 is shown in withdrawn position, with closure 240 securable to the end point of the entry aperture. The closure device 292 is configured to move to an upper position (see, FIG. 5), typically when the transfer container 200 is positioned at the desired storage compartment 100.

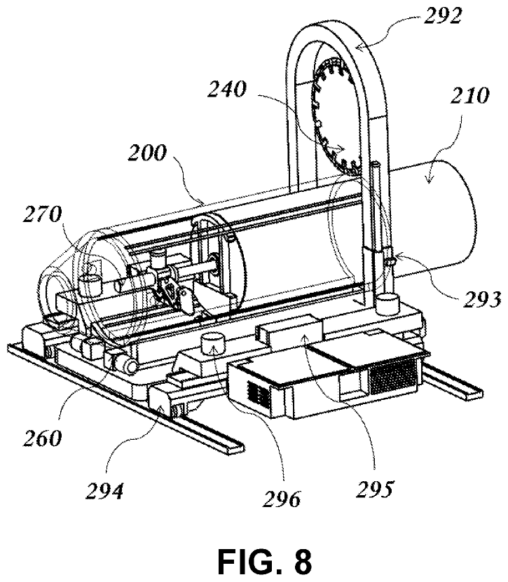

FIG. 8 shows the closure 240 raised to the open position to initiate transfer of the storage canister 210 from transfer container 200 to the selected storage compartment 100 (not shown). In this embodiment the storage canister 210 is transferred horizontally into the storage compartment 100. The vertical closure device 292 is shown in the extended position with the closure 240 removed from the end point of the cavity of the exit aperture from the transfer container 200.

In operation, the transport device 220 transports the storage canister 210 to the selected storage compartment 100. The transfer container 200 is aligned to the selected storage compartment 100 using alignment device 293, which is configured to provide location feedback to transfer container track positioning 294, and transfer container height positioning 295.

In this embodiment a transverse drive 296 docks the transfer container 200 to the final repository storage 100 cavity. The transfer drive 260 transfers the storage canister 210 over the entire length of transfer container 200, and the grapple drive 270 then completes transfer of the storage canister 210 into the selected deep repository storage compartment 100.

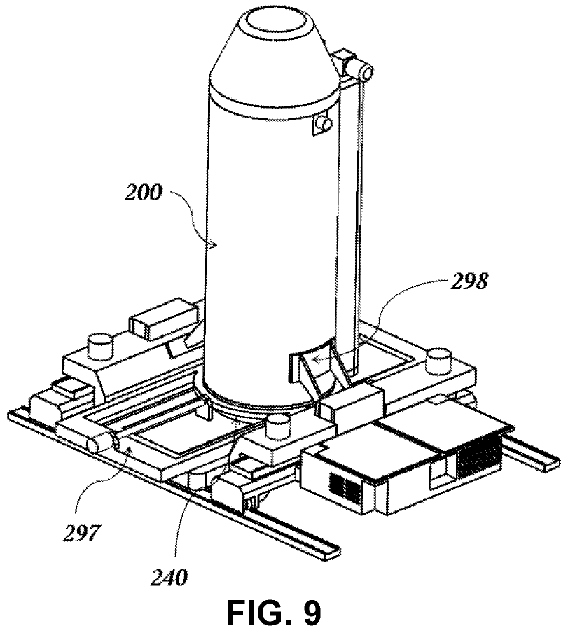

FIG. 9 shows a transport configuration of transfer container 200 for the conveyance from the deep repository main hub 80 to the selected storage compartment 100, with the transfer container 200 in a vertical orientation. A horizontal closure device 297 for closure 240 of transfer container 200 is shown in a closed position with closure 240 securable to the end of the transfer container 200. Structural bracing 298 may be provided to improve stability during conveyance to the transfer container 200.

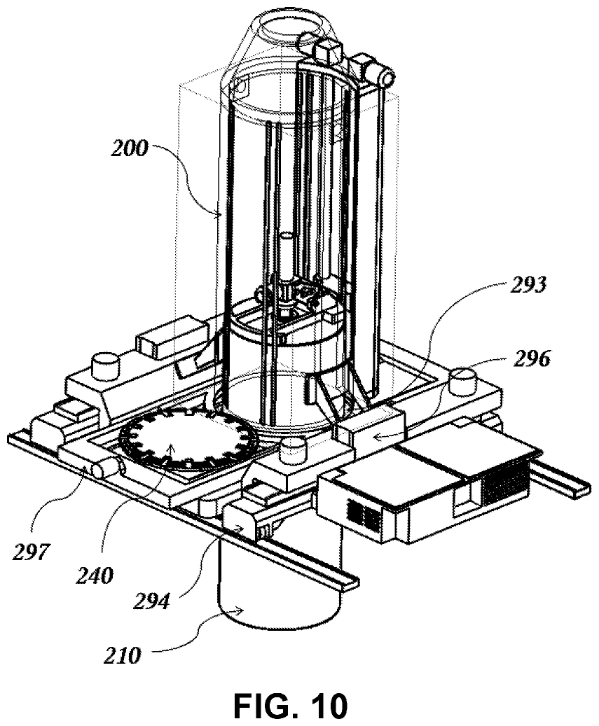

Refer now to FIG. 10, shows the transfer configuration of the vertical transfer container 200 for the transfer of storage canister 210 from transfer container 200 to selected storage compartment 100 (not shown), to allow the transfer of the storage canister 210 in a vertical direction. The horizontal closure device 297 of transfer container 200 is shown in the open position with the canister closure 240 removed from the end of the transfer container 200.

As such the transfer container 200 is aligned to the selected storage compartment 100. For example, the storage compartment 100 may be accurately aligned to the storage compartment 100 using a first alignment device 293 providing location feedback to transfer container track positioning 294, and a traverse drive 296 for alignment to the storage compartment 100.

Transfer drive 260 lowers the storage canister 210 over the length of the transfer container 200, subsequently, grapple drive 270 continues transfer of the storage canister 210 into the selected storage compartment 100.

The embodiments of the disclosed subject matter in which an exclusive property or privilege is claimed are defined as follows:

1. A geological repository comprising:
a subterranean spiral tunnel drilled or bored in a geological formation;
a plurality of spaced-apart storage compartments individually accessible from the spiral tunnel, wherein the storage compartments are configured to receive storage canisters transported through the spiral tunnel;
wherein the plurality of storage compartments are formed in a body of rock.

2. The geological repository of claim 1, wherein the subterranean spiral tunnel comprises a plurality of subterranean spiral tunnels.

3. The geological repository of claim 1, further comprising a vertical shaft extending from an upper ground surface to provide access to the subterranean spiral tunnel.

4. The geological repository of claim 1, further comprising a ramp extending from an upper ground surface to provide access to the subterranean spiral tunnel.

5. The geological repository of claim 3, wherein the vertical shaft extending from the upper ground surface engages the spiral tunnel through a subterranean main hub.

6. The geological repository of claim 5, further comprising a ventilation shaft, a utility shaft, and a ground water management system, wherein the ventilation shaft, the utility shaft, and the ground water management system are fluidly connected to the main hub.

7. The geological repository of claim 1, wherein the plurality of storage compartments extend horizontally or vertically from the spiral tunnel.

8. The geological repository of claim 1, wherein the plurality of storage compartments comprise pairs of aligned storage compartments that extend in opposite directions from the spiral tunnel.

9. The geological repository of claim 1, wherein the plurality of storage compartments comprise multiple layers of barriers.

10. The geological repository of claim 9, wherein the multiple layers of barriers comprise a barrier layer comprising a non-conductive material and a barrier layer comprising a conductive material.

11. The geological repository of claim 1, wherein the spaced apart storage compartments comprise a plurality of closure layers, including at least one engineered layer and at least one natural barrier, wherein the natural barrier comprises a rock barrier.

12. The geological repository of claim 11, wherein the engineered layer comprises a conductive material, and further comprises a second engineered barrier comprising a non-conductive material.

13. The geological repository of claim 3, wherein the vertical shaft comprises a plurality of vertical shafts.

14. A system comprising a geological repository of claim 1, and further comprising transfer container configured to receive a storage canister, and a transport device configured to transport the storage canister to a selectable one of the storage compartments, wherein the transport device comprises a track system disposed in the spiral tunnel, and further comprising a transfer device configured to transfer the storage canister from the transfer container to the selected storage compartment.

15. The system of claim 14, wherein the transport device is remotely controlled.

16. The system of claim 14, wherein the transfer device is integrated into the transfer container.

17. The system of claim 14, wherein the transfer device is remotely operated.
